(19) United States
(12) Patent Application Publication
(10) Pub. No.: US 2016/0318626 A1
(43) Pub. Date: Nov. 3, 2016

(54) METHOD AND SYSTEM FOR MANAGING A PLURALITY OF CRITICAL FUNCTIONS IN AN AIRCRAFT

(71) Applicant: THALES CANADA INC., Toronto (CA)

(72) Inventors: Franck Edward Gansmandel, Montréal (CA); Jacques Nacouzi, Montréal (CA); Étienne Alepins, Pointe-Claire (CA); Yvon Nazon, Montréal (CA); Patrick Cadotte, Dollard-des-Ormeaux (CA); Frédérick Clément, Pincourt (CA)

(21) Appl. No.: 15/105,217

(22) PCT Filed: Dec. 17, 2014
(86) PCT No.: PCT/CA2014/000899

§ 371 Date: Jun. 16, 2016

Related U.S. Application Data
(60) Provisional application No. 61/918,234, filed on Dec. 19, 2013.

(51) Int. Cl. B64D 47/00; H04L 29/08

(52) U.S. Cl. CPC B64D 47/00; H04L 67/12

(57) ABSTRACT

A system and a method are disclosed for managing a plurality of critical functions in an aircraft, the system comprising at least one data providing unit for providing digital signals, wherein at least one digital signal is associated with a given critical function of the plurality of critical functions; at least one transmission path coupled to the at least one providing unit; a memory unit for storing an operating system and a plurality of critical applications managing the plurality of critical functions; and a processing unit operatively coupled to the memory unit and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

### CROSS-REFERENCE TO RELATED APPLICATION

This patent application claims priority on U.S. Patent Application No. 61/918,234, filed on Dec. 19, 2013, which is incorporated herein by reference.

### FIELD

The invention relates to management of aircraft systems. More precisely, the invention pertains to a method and system for managing a plurality of critical functions in an aircraft.

### BACKGROUND

Critical controllers have been designed to manage one or a small number of aircraft functions. As a consequence, aircrafts often host as many controllers as there are aircraft ancillary systems to manage.

Each controller is designed specifically for the ancillary system it is meant to manage, and adapted to their specific effectors, sensors, valves and actuators.

For an aircraft original equipment manufacturer (OEM), this results in the obligation to make room for a large number of LRUs with the overall risk of lower aircraft reliability, increased complexity, and with a weight and volume penalty.

There is a need for a method and a system for managing a plurality of critical functions in an aircraft that will overcome at least one of the above-identified drawbacks.

Features of the invention will be apparent from review of the disclosure, drawings and description of the invention below.

### BRIEF SUMMARY

According to a broad aspect, there is disclosed a system for managing a plurality of critical functions in an aircraft, the system comprising at least one data providing unit for providing digital signals, wherein at least one digital signal is associated with a given critical function of the plurality of critical functions; at least one transmission path coupled to the at least one data providing unit; a memory unit for storing an operating system and a plurality of critical applications managing the plurality of critical functions and a processing unit operatively coupled to the memory unit and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

In accordance with an embodiment, the data providing unit is digitizing an incoming analog signal.

In accordance with an embodiment, the at least one data providing unit is connected to at least one of a variable differential transformer, a proximity sensor, a pressure sensor, a temperature sensor, a strain gauge, a power output, a transducer, a tachymeter and a resolver.

In accordance with an embodiment, the at least one transmission path operates using a standard selected from a group consisting of ARINC429, ARINC629, ARINC664, ARINC825, MIL-STD-1553, RS422, RS485, RS232 and SPI.

In accordance with an embodiment, the at least one transmission path is bidirectional.

In accordance with an embodiment, the at least one data providing unit comprises a remote data concentrator.

In accordance with an embodiment, the at least one transmission path comprises a network equipment.

In accordance with an embodiment, the network equipment comprises a communication switch.

In accordance with an embodiment, the fast loops have a duration equal to or greater than 1 msec.

In accordance with an embodiment, the processing unit further performs at least one of receiving and transmitting a digital signal from/to a given location.

In accordance with an embodiment, the digital signal is provided according to a standard selected from a group consisting of ARINC429, ARINC629, ARINC664, ARINC825, MIL-STD-1553, RS422, RS485, RS232 and SPI.

According to a broad aspect, there is disclosed a method for managing a plurality of critical functions in an aircraft, the method comprising obtaining a plurality of digital signals, wherein at least one digital signal of the plurality of digital signals is associated with a given critical function and executing a plurality of critical applications managing the plurality of critical functions, each critical application with at least one digital signal of the plurality of digital signals, wherein the execution of the plurality of critical applications is managed by an operating system to accommodate fast loops and to ensure independence of the plurality of critical applications.

In accordance with an embodiment, the obtaining of a plurality of digital signals comprises receiving a plurality of analog signals and digitizing the plurality of digital signals to provide the plurality of digital signals.

In accordance with an embodiment, more than one computing lane is provided, further wherein the executing of a plurality of critical applications managing the plurality of critical functions is performed using the more than one computing lane.

In accordance with an embodiment, the method further comprises assigning a first portion of given critical application to a first given computing lane and a second portion of the given critical application to another computing lane.

In accordance with an embodiment, the assigning is amended.

According to a broad aspect, there is disclosed a system for managing a plurality of critical functions in an aircraft, the system comprising at least one data providing unit for providing digital signals, wherein at least one digital signal is associated with a given critical function of the plurality of critical functions; at least one transmission path coupled to the at least one data providing unit and at least one computing lane, the at least one computing lane for storing an operating system and a plurality of critical applications managing the plurality of functions and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

In accordance with an embodiment, the system comprises a plurality of computing lanes, wherein at least one portion of a given application is executed by a given computing lane and at least one other portion of the given application is executed by another computing lane.

In accordance with an embodiment, the at least one portion of the given application is selected from a group consisting of a command (COM) portion and a monitoring (MON) portion.

In accordance with an embodiment, the at least one other portion of the given application is selected from a group consisting of a command (COM) portion and a monitoring (MON) portion.

In accordance with an embodiment, a processing using an outcome from the execution of the at least one portion of the given application and an outcome from the execution of the at least one other portion of the given application is further performed.

In accordance with an embodiment, the processing comprises one of performing a comparison, performing a vote and performing a selection.

An advantage of the system disclosed herein is that it can provide a more compact packaging of the critical applications since the critical applications are managed by a single or multiple processing units and execution system.

Another advantage of the system disclosed herein is that it requires fewer parts than a prior-art system, which translates into a better overall mean time before failure (MTBF), reduce power requirement and an optimized weight and volume.

Another advantage of the system disclosed herein is that it may provide flexibility for evolving requirements.

Another advantage of the system disclosed herein is that it may improve dispatch reliability by offering additional availability through greater redundancy.

### BRIEF DESCRIPTION OF THE DRAWINGS

In order that the invention may be readily understood, embodiments of the invention are illustrated by way of example in the accompanying drawings.

FIG. 1 is a diagram that shows an embodiment of a system for managing a plurality of critical functions in an aircraft; wherein the system comprises a single controller.

FIG. 2 is a diagram that shows an embodiment of a first configuration in which a system for managing a plurality of critical functions in an aircraft comprises a plurality of controllers.

FIG. 3 is a diagram that shows an embodiment of a second configuration in which a system for managing a plurality of critical functions in an aircraft comprises a single controller.

FIG. 4 is a diagram that shows an embodiment of a third configuration in which a system for managing a plurality of critical functions in an aircraft is used and comprises a single controller.

FIG. 5 is a flowchart that shows an embodiment of a method for managing a plurality of critical functions in an aircraft. According to a first processing step, a plurality of digital signals is obtained.

FIG. 6 is a flowchart that shows an embodiment for obtaining the plurality of digital signals.

Further details of the invention and its advantages will be apparent from the detailed description included below.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus does not limit the term or phrase it explains. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “respective” and like terms mean “taken individually.” Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is,” and thus limits the term or phrase it explains. For example, in the sentence “the computer sends data (i.e., instructions) over the Internet,” the term “i.e.” explains that “instructions” are the “data” that the computer sends over the Internet.

The term “critical aircraft system” and like terms are often abbreviated from Safety-Critical systems. By definition, it relates to those systems whose failure could result in loss of life, or catastrophic impact on aircraft systems; they include systems such as flight deck controls, such as levers, sticks, pedals, switches, as well as ancillary systems such as flight controls system, landing gear control system, braking control system, fuel systems, cabin pressurization system, etc.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase do not mean instances of another such term/phrase must have a different meaning. For example, where a statement renders the meaning of “including” to be synonymous with “including but not limited to,” the mere usage of the phrase “including but not limited to” does not mean that the term “including” means something other than “including but not limited to.”

Various embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

As disclosed below, the invention may be implemented in numerous ways.

With all this in mind, the present invention is directed to a system and a method for managing a plurality of critical functions in an aircraft.

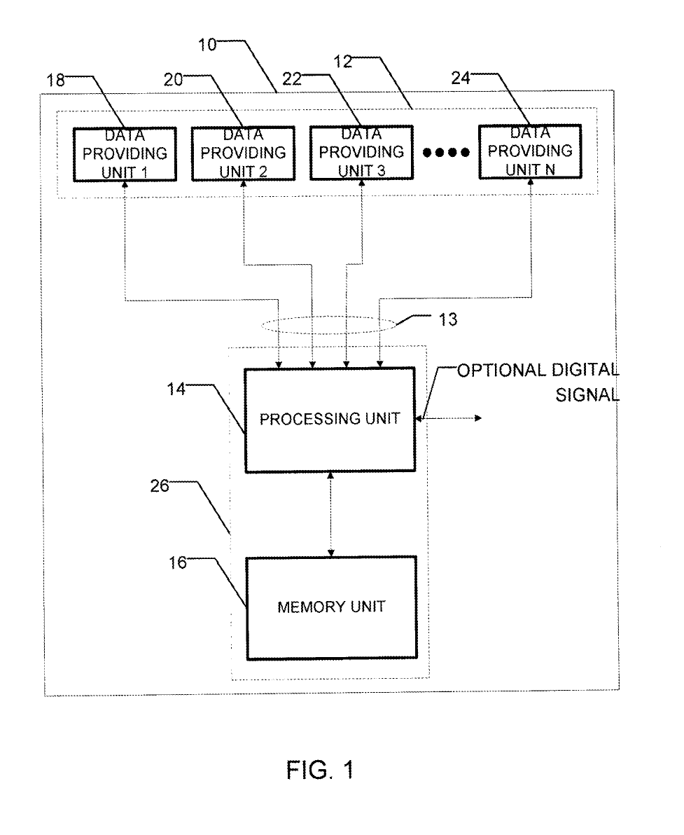

Now referring to FIG. 1, there is shown an embodiment of a system 10 for managing a plurality of critical functions in an aircraft.

It will be appreciated that the system 10 for managing a plurality of critical functions in an aircraft may be used in multiple avionics architectures, or configurations, to perform different aircraft functions as further disclosed below.

The system 10 for managing a plurality of critical functions in an aircraft comprises at least one data providing unit 12, at least one transmission path 13, a processing unit 14 and a memory unit 16.

More precisely, the at least one data providing unit 12 comprises, for instance, data providing unit 18, data providing unit 20, data providing unit 22 and data providing unit 24.

Each of the at least one data providing unit 12 is used for providing at least a digital signal indicative of a signal received.

It will be appreciated that a data providing unit may be connected to various inputs such as, for instance, variable differential transformers (VDTs), proximity sensors, pressure sensors, temperature sensors, strain gauges, power output, transducers, tachymeter, resolvers, etc.

It will be appreciated by the skilled addressee that variable differential transformers either linear (LVDT) or rotary (RVDT), are electrical transformers used for measuring movement (longitudinal or rotational) of systems mechanical components in safety critical environments. The variable differential transformer converts a position or displacement from a mechanical reference, zero or null position, into a proportional electrical signal containing phase (for direction) and amplitude (for distance) information. The linear variable differential transformer has three solenoid coils placed end to end around a tube. The center coil is the primary, and the two outer coils are the top and bottom secondary. A cylindrical ferromagnetic core, attached to the object whose position is to be measure, slides along the axis of the tube. An alternating current drives the primary and causes a voltage to be induced in each secondary proportional to the length of the core linking to the secondary.

It will also be appreciated by the skilled addressee that a proximity sensor switch is a sensor able to detect the presence of nearby objects without any physical contact, and in some cases the actual distance between the sensor and the target. The sensor contains only a passive sensing element based on the variable inductance principle. This allows the sensor to be highly reliable and operate in extreme environments.

It will be therefore appreciated that in this embodiment the data providing unit is digitizing an analog signal originating from the input.

The at least one digital signal indicative of a signal received is provided by a data providing unit to the processing unit 14 using a transmission path of the at least one transmission path 13.

It will be appreciated that at least one digital signal generated by a data providing unit of the at least one data providing unit 12 is associated with a given critical function of the plurality of critical functions.

In fact, it will be appreciated that the system 10 for managing a plurality of critical functions in an aircraft may be used with mechanical systems with little or no digital interfaces, and where each of the system components, such as actuator, sensor, gauge, lever, etc., is linked through its own specific physical and electrical interface to a corresponding data providing unit of the at least one data providing unit 12. The corresponding data providing unit will be responsible for receiving a signal and digitizing it if it is not in a digital form. The digitized signal will be then be transmitted to the processing unit 14, as mentioned earlier.

In one embodiment, a data providing unit may receive a signal from the processing unit 14 and provides a signal to a given system component associated, or not, with a critical function in response thereof. The signal provided by the data providing unit to the given system component may be either in a digital or in an analog form.

As mentioned above, the system 10 for managing a plurality of critical functions in an aircraft comprises at least one transmission path 13 coupled to the at least one data providing unit 12.

It will be appreciated by the skilled addressee that the at least one transmission path 13 may be of various types.

In one embodiment, the at least one transmission path 13 operates using a standard selected from a group consisting of ARINC429, ARINC629, ARINC664, ARINC825, MIL-STD-1553, RS422, RS485, RS232 and SPI. The skilled addressee will appreciate that various alternative embodiments may be possible. In particular, it will be appreciated that in one embodiment the at least one transmission path 13 is bidirectional.

It will be further appreciated by the skilled addressee that the at least one transmission path 13 may also comprise network equipment such as a communication switch, for instance.

The memory unit 16 is used for storing an operating system and a plurality of critical applications. The plurality of critical applications is managing the plurality of critical functions. It will be appreciated that the memory unit 16 may be of various types.

The processing unit 14 is operatively coupled to the memory unit 16 and to the at least one data providing unit 12 configured to receive the digital signals along the at least one transmission path 13.

The processing unit 14 is used for executing the operating system and the plurality of critical applications stored in the memory unit 16.

It will be appreciated that the execution of the plurality of critical applications and the partitioning of all resources are managed by the operating system and by hardware mechanisms to ensure independence of the plurality of critical applications. It will be appreciated that independence of the plurality of critical applications is ensured by robust time and space partitioning of the plurality of critical applications, as per DO-297 in one embodiment.

It will be appreciated that the robust time partitioning is required to ensure that critical applications complete their processing without interrupting one another. As a consequence, an application presenting a problem, such as over- or under-running, presenting an interruption overflow, etc., is detected and managed within its partition without affecting the other applications running on the processing unit 14.

It will be appreciated that the robust space partitioning ensures a similar concept, but in terms of reserved memory segments, computer registers and interface access that are managed with predetermined memory access rules. It will be appreciated that this allows the processing unit 14 to keep on executing a partition containing a given critical application, even if another application has demonstrated a problem due to the fact that each partition/application has its own segregated data stream in the memory unit 16.

In one embodiment, the memory unit 16 is provided with a toolset which enables the various ancillary systems providers to deliver their designs in the form of high-level models for their respective functions. The toolset is then capable of translating the model into a processing unit executable partition, and the operating system ensures execution independence of each critical application with respect to the other critical applications/partitions. The skilled addressee will appreciate that this may improve life-cycle efficiency, independence between the various functions, and reduces the amount of regression tests required on the controller in the event of an aircraft system evolution.

Moreover it will be appreciated that the execution of the plurality of critical applications is managed to accommodate fast loops and a minimized latency. The fast loop has a duration typically equal or above 1 msec. It will be further appreciated that both the rapid iteration cycle and the minimized latency are required for being able to control various electrical, mechanical, hydraulic and pneumatic systems of the aircraft associated with failure modes that can lead to human fatalities.

The operating system is therefore capable of accommodating fast loops and of ensuring robust space and time partitioning. This is achieved through the use of hardware components configured by the software. Application code and data are partitioned through the use of the Memory Protection Unit (MPU) embedded in the processing unit 14. Digital and analog Input/Output buses spatial partitioning is virtualized. This is done, in one embodiment, by creating mirror sections in the memory unit 16 that represent each data/message of each bus. Access rights to each section (thus to each data of each bus) are implemented through the use of the MPU, using the same paradigm as code/data sections partitioning scheme described above. Bus data reception and transmission are performed using a Direct Memory Access (DMA) component and/or a second processing core that create a bridge between the mirror memory sections and the physical buses. This is performed while maintaining a minimal jitter on the main processing core.

It will be appreciated that in this embodiment the partitions share a common transmission digital bus through partitioning on the messages Identifiers (IDs). Each message ID is allocated to a single partition such that the single physical bus is seen by partitions as multiple partitioned virtual buses. It will be further appreciated that multiple messages IDs can be allocated to a single partition. There might be more than one such digital bus. The transmission digital bus temporal partitioning is achieved by allocating time frames to partitions. That time frame is pre-allocated. During that time frame, only the associated partition can send messages. When a partition is trying to transmit while the current time frame is not allocated to that partition, the messages are put in a transmission FIFO until the next time frame allocated to that partition. At that time, the messages in the FIFO will be transmitted on the bus.

It will be appreciated that the combination of the processing unit 14 and the memory unit 16 may also be referred to as a controller 26.

As a matter of fact, it will be appreciated that a combination of a given processing unit and a given memory unit may be also referred to as a computing lane. A controller may therefore comprise one computing lane.

Alternatively, a controller may comprise more than one computing lane.

For instance, a given controller may be configured as a pair of self and cross-checking command (COM) and monitoring (MON) computing lanes. The inputs to each computing lane are duplicated and both computing lanes are identical, and designed to meet Design Assurance Level A, in accordance with RTCA/DO-254. The application software residing on each computing lane such as the operating system or the implementation of the function is developed separately in two different programming languages, in accordance with RTCA/DO-178 Design Assurance Level A. It will be appreciated by the skilled addressee that this arrangement provides a very high level of integrity allowing the system for managing a plurality of critical applications in an aircraft to host critical aircraft system applications such as high lift system, braking and others.

In one embodiment, a computing lane is an independent system laid out on one circuit card assembly. It includes a dedicated power supply of 28 VDC in one embodiment.

In one embodiment, there is a command (COM) lane and a monitoring (MON) lane with the capability to reconfigure in various schemes such as COM/MON and COM/COM. As mentioned above, it will be appreciated that each software application is developed separately in two different programming languages.

It will be appreciated that in the embodiment where the controller comprises more than one lane, each lane may be used to host any portion of a given critical application. The portion may be selected from a group consisting of a command (COM) portion, a monitoring (MON) portion, etc.

In particular, it will be appreciated that in the case of a plurality of critical applications, each of a plurality of lanes may host a different portion of the plurality of critical applications. The assignment of a given portion of a given critical application on a given lane may be amended.

In addition, it will be appreciated that the outcome of a given portion of a given critical application may be further processed. The processing may comprise performing a comparison between more than one outcome, performing a voting between more than one outcome, etc. It will be appreciated that the purpose of such processing is to increase the integrity of the outcome of the application.

In addition, it will be appreciated that the outcome of a given portion of a given critical application may be further processed. The processing may comprise performing a selection between more than one outcome. It will be appreciated that the purpose of such processing is to increase the availability of the outcome of the application.

It will be further appreciated that the processing unit 14 may receive directly and/or transmit an optional digital signal to a remote location, not shown. It will be appreciated that the optional digital signal may be of various types. In fact, the optional digital signal may be transmitted using a standard selected from a group consisting of ARINC429, ARINC629, ARINC664, ARINC825, MIL-STD-1553, RS422, RS485, RS232 and SPI. The skilled addressee will appreciate that various alternative embodiments may be possible.

Since a given data providing unit may be integrated inside the controller 26, it will be appreciated that the controller 26 may also receive an analog signal via the data providing unit located inside it and convert it into a digital signal using the given data providing unit.

It will be appreciated that the system 10 for managing a plurality of critical functions in an aircraft may be assembled in various combinations to perform the assigned functions.

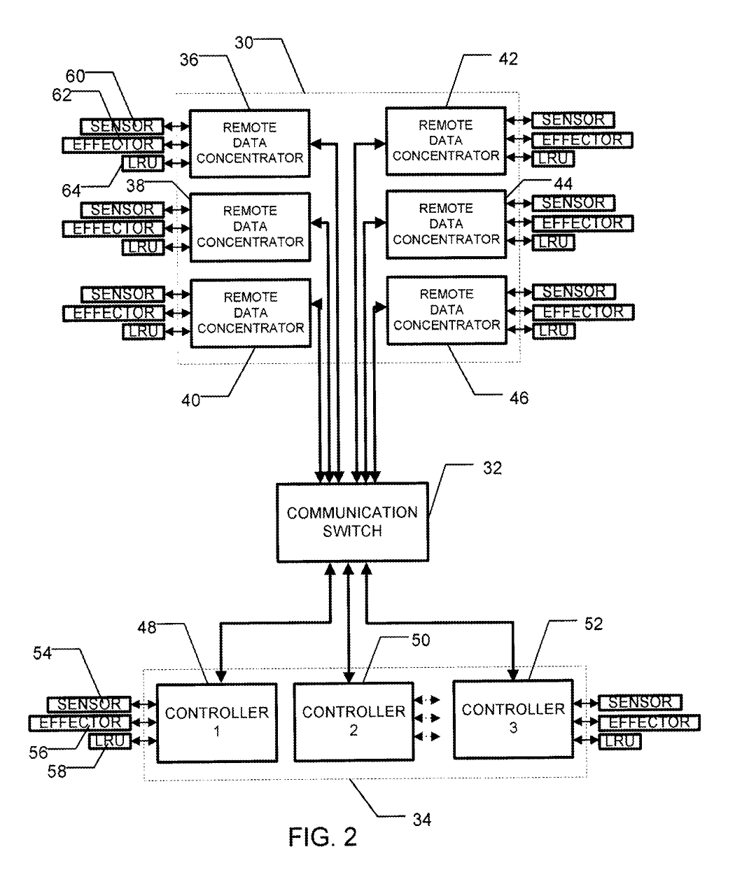

Now referring to FIG. 2, there is shown a first configuration in which the system for managing a plurality of critical functions in an aircraft may be used.

As shown in FIG. 2, the system is assembled in multiple units.

It will be appreciated that this configuration may be used in highly critical applications, where functional redundancy is required, or in applications where multiple units are required to handle the required computation and data-handling throughput.

More precisely, the system for managing a plurality of critical functions in an aircraft may comprise a plurality of controllers 34 comprising a first controller 48, a second controller 50 and a third controller 52.

Each of the first controller 48, the second controller 50 and the third controller 52 is operatively connected to a plurality of data providing units 30.

The plurality of data providing units 30 comprises a first remote data concentrator 36, a second remote data concentrator 38, a third remote data concentrator 40, a fourth remote data concentrator 42, a fifth remote data concentrator 44 and a sixth remote data concentrator 46.

It will be appreciated that a remote data concentrator is adapted to receive and transmit data to a corresponding group of sensors, effectors and LRUs.

For instance, the remote data concentrator 36 is adapted to receive and transmit data to a group of sensors 60, a group of effectors 62 and a group of LRU 64.

It will be appreciated that, while the data shared between the remote data controller 36, which is an embodiment of a data providing unit, and the corresponding group of sensors 60, effectors 62 and the group of LRU 64 may be of the analog or of the digital type, the data shared between the data providing unit 36 and at least one of the first controller 48, the second controller 50 and the third controller 52 is digital.

Accordingly, it will be appreciated by the skilled addressee that each of the plurality of remote data controllers 30 may comprise an analog-to-digital converter for the purpose of converting an incoming analog signal into a digital signal for transmission to at least one of the first controller 48, the second controller 50 and the third controller 52. Each of the plurality of remote data controllers 30 may further comprise a digital-to-analog converter for the purpose of converting an incoming digital signal provided by at least one of the first controller 48, the second controller 50 and the third controller 52 into an analog signal for transmission back to a corresponding effector, for instance.

Still referring to FIG. 2, it will be appreciated that the first controller 48, the second controller 50 and the third controller 52 may be interconnected to each other using a data bus, not shown. In one embodiment, the data bus operates according to a standard selected from a group consisting of ARINC429, ARINC629, ARINC664, ARINC825, MIL-STD-1553, RS422, RS485, RS232 and SPI. The skilled addressee will appreciate that various alternative embodiments may be possible. In particular, it will be appreciated that a dissimilar bus may be used.

It will be further appreciated that in one embodiment, not shown in FIG. 2, the first controller 48, the second controller 50 and the third controller 52 may be operatively connected to the flight control computers of the aircraft.

In such embodiment, the first controller 48, the second controller 50 and the third controller 52 may transmit, for instance, actuator and sensor data to the flight control computers of the aircraft.

It will be appreciated that in the embodiment disclosed in FIG. 2, a communication switch 32 may be used. It will be appreciated by the skilled addressee that alternatively more than one communication switch may be used for redundancy purposes.

More precisely, the communication switch 32 is operatively connected to each of the plurality of remote data controllers 30 and to the plurality of controllers 34. The skilled addressee will appreciate that various alternative embodiments may be possible for the communication switch 32.

Also, it will be appreciated that each of the first controller 48, the second controller 50 and the third controller 52 may comprise a local data providing unit, not shown.

As a consequence, the first controller 48 may receive a signal provided by the sensors 54, a signal provided by the effectors 56 and a signal provided by the LRU 58.

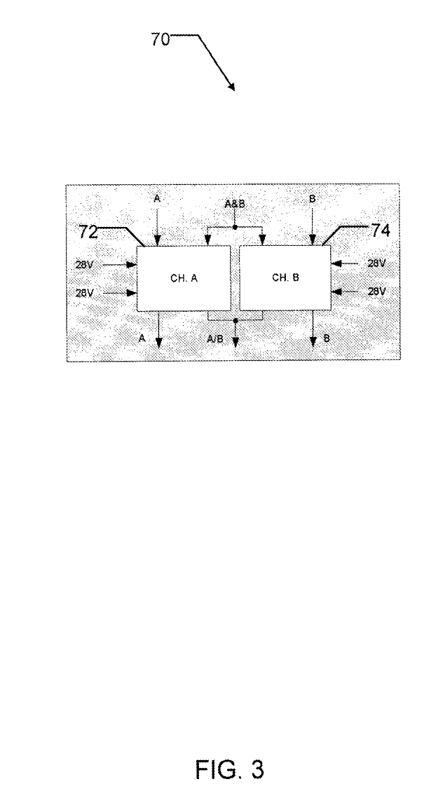

Now referring to FIG. 3, there is shown another configuration in which an embodiment of a system for managing a plurality of critical functions in an aircraft may be used.

In this embodiment a single controller is used.

It will be appreciated that this configuration may be used in the case where a single controller can perform the required computation and data-handling throughput.

In this embodiment, the system for managing a plurality of critical functions in an aircraft may be used, for instance, for performing landing gear, front-wheel steering and wheel-braking functions.

As shown in FIG. 3, the system 70 for managing a plurality of critical functions in an aircraft comprises a first channel 72 and a second channel 74.

As mentioned above, each of the first channel 72 and the second channel 74 is composed of two computing lanes.

The skilled addressee will appreciate that this configuration ensures a high level of integrity which is desirable for performing functions such as landing gear, front-wheel steering and wheel-braking functions.

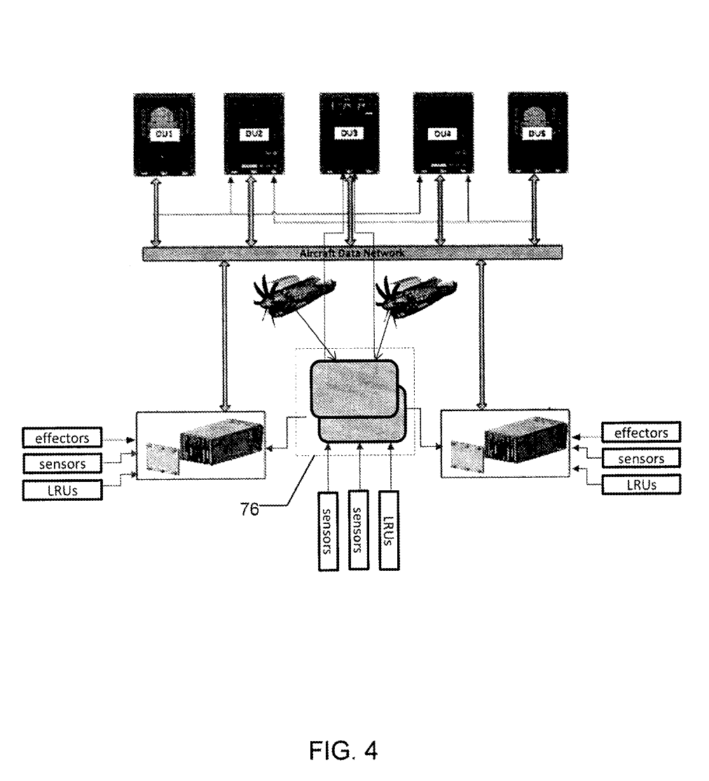

Now referring to FIG. 4, there is shown another configuration in which an embodiment of a system for managing a plurality of critical functions in an aircraft is used.

It will be appreciated that in this configuration only one part of the system for managing a plurality of critical functions in an aircraft is used.

In fact, in one embodiment, two of the four lanes of a controller may be used for handling the requirement of the function to be performed.

More precisely and in this embodiment, the system for managing a plurality of critical functions in an aircraft comprises a controller 76 used for performing a data concentration function for a multi-function display located in the cockpit of the aircraft.

It will be appreciated that for this application only two computing lanes of a complete controller are used in a COM/COM configuration to implement the required functions.

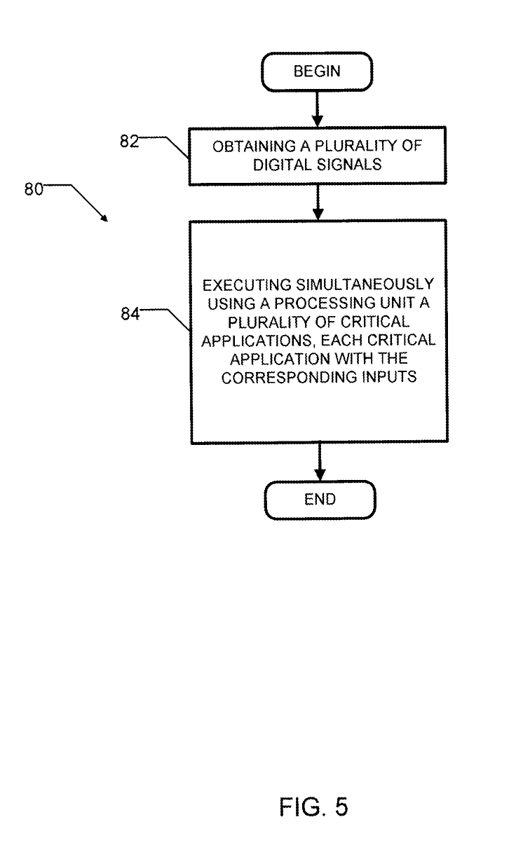

Now referring to FIG. 5, there is shown an embodiment of a method 80 for managing a plurality of critical functions in an aircraft.

According to processing step 82, a plurality of digital signals is obtained. It will be appreciated that at least one digital signal of the plurality of digital signals obtained is associated with a given critical function.

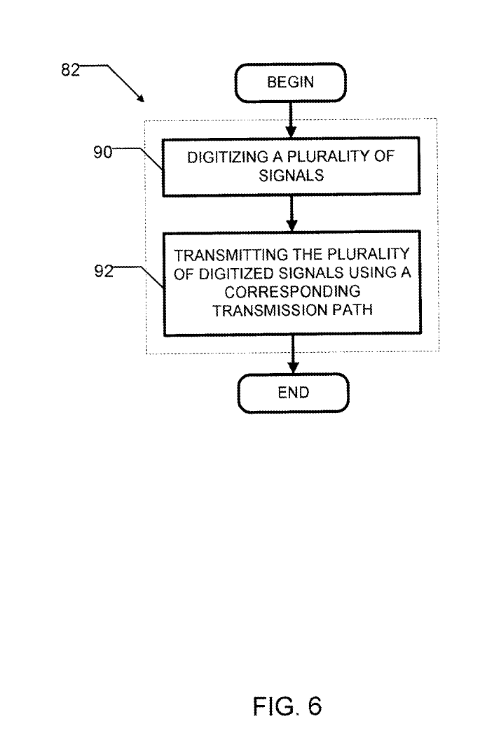

Now referring to FIG. 6, there is shown an embodiment for obtaining the plurality of digital signals.

According to processing step 90, a plurality of signals is digitized.

The plurality of signals may be originating from various sources. In one embodiment the plurality of signals originates from at least one of sensors, effectors and LRUs.

In an alternative embodiment, the plurality of signals is already in the digital format and are therefore not digitized again.

According to processing step 92, the plurality of digitized signals is transmitted using a corresponding transmission path.

Now referring back to FIG. 5 and according to processing step 84, a plurality of critical applications is executed. It will be appreciated that the plurality of critical applications is managing the plurality of critical functions. The plurality of critical applications is executed with corresponding digitized signals of the plurality of digitized signals using a processing unit.

The execution of the plurality of critical applications is managed using an operating system to accommodate fast loops and to ensure independence of the plurality of critical applications.

It will be appreciated that, in one embodiment, more than one computing lane is provided. In such embodiment, the executing of a plurality of critical applications managing the plurality of critical functions is performed using the more than one computing lane.

Moreover, it will be appreciated that, in such embodiment, a first portion of given critical application may be assigned to a first given computing lane while a second portion of the given critical application is assigned to another computing lane.

It will be further appreciated that, in one embodiment, the assignment is amended.

It will be appreciated that, in another embodiment, the system for managing a plurality of critical functions in an aircraft comprises at least one data providing unit for providing digital signals, wherein at least one digital signal is associated with a given critical function of the plurality of critical functions. The system for managing a plurality of critical functions in an aircraft further comprises at least one transmission path coupled to the at least one data providing unit and at least one computing lane, the at least one computing lane for storing an operating system and a plurality of critical applications managing the plurality of functions and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

In one embodiment of the system for managing a plurality of critical functions in an aircraft, a plurality of computing lanes is provided. At least one portion of a given application is executed by a given computing lane and at least one other portion of the given application is executed by another computing lane.

It will be appreciated that in one embodiment, at least one portion of the given application is selected from a group consisting of a command (COM) portion and a monitoring (MON) portion, and at least one other portion of the given application is selected from a group consisting of a command (COM) portion and a monitoring (MON) portion.

It will be further appreciated that, in one embodiment, a processing is further performed using an outcome from the execution of the at least one portion of the given application and an outcome from the execution of the at least one other portion of the given application. The processing may comprise one of performing a comparison, performing a vote and performing a selection.

An advantage of the system disclosed herein is that it can provide a more compact packaging of the critical applications since the critical applications are managed by a single or multiple processing units and execution system.

Another advantage of the system disclosed herein is that it requires fewer parts than a prior-art system, which translates into a better overall mean time before failure (MTBF), reduce power requirement and an optimized weight and volume.

Another advantage of the system disclosed herein is that it may provide flexibility for evolving requirements.

Another advantage of the system disclosed herein is that it may improve dispatch reliability by offering additional availability through greater redundancy.

Although the above description relates to a specific preferred embodiment as presently contemplated by the inventor, it will be understood that the invention in its broad aspect includes functional equivalents of the elements described herein.

Clause 1. A system for managing a plurality of critical functions in an aircraft, the system comprising:

at least one data providing unit for providing digital signals, wherein at least one digital signal is associated with a given critical function of the plurality of critical functions;

at least one transmission path coupled to the at least one data providing unit;

a memory unit for storing an operating system and a plurality of critical applications managing the plurality of critical functions; and

a processing unit operatively coupled to the memory unit and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

Clause 2. The system for managing a plurality of critical functions in an aircraft as claimed in clause 1, wherein the data providing unit is digitizing an incoming analog signal.
Clause 3. The system for managing a plurality of critical functions in an aircraft as claimed in clause 1, wherein the at least one data providing unit is connected to at least one of a variable differential transformer, a proximity sensor, a pressure sensor, a temperature sensor, a strain gauge, a power output, a transducer, a tachymeter and a resolver.
Clause 4. The system for managing a plurality of critical functions in an aircraft as claimed in any one of clauses 1 to 3, wherein the at least one transmission path operates using a standard selected from a group consisting of ARINC429, ARINC629, ARINC664, ARINC825, MIL-STD-1553, RS422, RS485, RS232 and SPI.
Clause 5. The system for managing a plurality of critical functions in an aircraft as claimed in any one of clauses 1 to 4, wherein the at least one transmission path is bidirectional.
Clause 6. The system for managing a plurality of critical functions in an aircraft as claimed in any one of clauses 1 to 5, wherein the at least one data providing unit comprises a remote data concentrator.
Clause 7. The system for managing a plurality of critical functions in an aircraft as claimed in any one of clauses 1 to 6, wherein the at least one transmission path comprises a network equipment.
Clause 8. The system for managing a plurality of critical functions in an aircraft as claimed in clause 7, wherein the network equipment comprises a communication switch.
Clause 9. The system for managing a plurality of critical functions in an aircraft as claimed in any one of clauses 1 to 8, wherein the fast loops have a duration equal to or greater than 1 msec.
Clause 10. The system for managing a plurality of critical functions in an aircraft as claimed in any one of clauses 1 to 9, wherein the processing unit further performs at least one of receiving and transmitting a digital signal from/to a given location.
Clause 11. The system for managing a plurality of critical functions in an aircraft as claimed in clause 10, wherein the digital signal is provided according to a standard selected from a group consisting of ARINC429, ARINC629, ARINC664, ARINC825, MIL-STD-1553, RS422, RS485, RS232 and SPI.
Clause 12. A method for managing a plurality of critical functions in an aircraft, the method comprising:

obtaining a plurality of digital signals, wherein at least one digital signal of the plurality of digital signals is associated with a given critical function;

executing a plurality of critical applications managing the plurality of critical functions, each critical application with at least one digital signal of the plurality of digital signals, wherein the execution of the plurality of critical applications is managed by an operating system to accommodate fast loops and to ensure independence of the plurality of critical applications.

Clause 13. The method for managing a plurality of critical functions in an aircraft as claimed in clause 12, wherein the obtaining of a plurality of digital signals comprises receiving a plurality of analog signals and digitizing the plurality of digital signals to provide the plurality of digital signals.
Clause 14. The method for managing a plurality of critical functions in an aircraft as claimed in any one of clauses 12 to 13, wherein more than one computing lane is provided, further wherein the executing of a plurality of critical applications managing the plurality of critical functions is performed using the more than one computing lane.
Clause 15. The method for managing a plurality of critical functions in an aircraft as claimed in clause 14, further comprising assigning a first portion of given critical application to a first given computing lane and a second portion of the given critical application to another computing lane.
Clause 16. The method for managing a plurality of critical functions in an aircraft as claimed in clause 15, wherein the assigning is amended.
Clause 17. A system for managing a plurality of critical functions in an aircraft, the system comprising:

at least one data providing unit for providing digital signals, wherein at least one digital signal is associated with a given critical function of the plurality of critical functions;

at least one transmission path coupled to the at least one data providing unit; and

at least one computing lane, the at least one computing lane for storing an operating system and a plurality of critical applications managing the plurality of functions and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

Clause 18. The system for managing a plurality of critical functions in an aircraft as claimed in clause 17, wherein the system comprises a plurality of computing lanes, wherein at least one portion of a given application is executed by a given computing lane and at least one other portion of the given application is executed by another computing lane.
Clause 19. The system for managing a plurality of critical functions in an aircraft as claimed in clause 18, wherein the at least one portion of the given application is selected from a group consisting of a command (COM) portion and a monitoring (MON) portion.
Clause 20. The system for managing a plurality of critical functions in an aircraft as claimed in clause 18, wherein the at least one other portion of the given application is selected from a group consisting of a command (COM) portion and a monitoring (MON) portion.
Clause 21. The system for managing a plurality of critical functions in an aircraft as claimed in clause 18, wherein a processing using an outcome from the execution of the at least one portion of the given application and an outcome from the execution of the at least one other portion of the given application is further performed.
Clause 22. The system for managing a plurality of critical functions in an aircraft as claimed in clause 21, wherein the processing comprises one of performing a comparison, performing a vote and performing a selection.

1. A system for managing a plurality of critical functions in an aircraft, the system comprising:
at least one data providing unit for providing digital signals, wherein at least one digital signal is associated with a given critical function of the plurality of critical functions;
at least one transmission path coupled to the at least one data providing unit;
a memory unit for storing an operating system and a plurality of critical applications managing the plurality of critical functions; and
a processing unit operatively coupled to the memory unit and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

2. The system for managing a plurality of critical functions in an aircraft as claimed in claim 1, wherein the data providing unit is digitizing an incoming analog signal.

3. The system for managing a plurality of critical functions in an aircraft as claimed in claim 1, wherein the at least one data providing unit is connected to at least one of a variable differential transformer, a proximity sensor, a pressure sensor, a temperature sensor, a strain gauge, a power output, a transducer, a tachymeter and a resolver.

4. The system for managing a plurality of critical functions in an aircraft as claimed in any one of claims 1 to 3, wherein the at least one transmission path operates using a standard selected from a group consisting of ARINC429, ARINC629, ARINC664, ARINC825, MIL-STD-1553, RS422, RS485, RS232 and SPI.

5. The system for managing a plurality of critical functions in an aircraft as claimed in any one of claims 1 to 4, wherein the at least one transmission path is bidirectional.

6. The system for managing a plurality of critical functions in an aircraft as claimed in any one of claims 1 to 5, wherein the at least one data providing unit comprises a remote data concentrator.

7. The system for managing a plurality of critical functions in an aircraft as claimed in any one of claims 1 to 6, wherein the at least one transmission path comprises a network equipment.

8. The system for managing a plurality of critical functions in an aircraft as claimed in claim 7, wherein the network equipment comprises a communication switch.

9. The system for managing a plurality of critical functions in an aircraft as claimed in any one of claims 1 to 8, wherein the fast loops have a duration equal to or greater than 1 msec.

10. The system for managing a plurality of critical functions in an aircraft as claimed in any one of claims 1 to 9, wherein the processing unit further performs at least one of receiving and transmitting a digital signal from/to a given location.

11. The system for managing a plurality of critical functions in an aircraft as claimed in claim 10, wherein the digital signal is provided according to a standard selected from a group consisting of ARINC429, ARINC629, ARINC664, ARINC825, MIL-STD-1553, RS422, RS485, RS232 and SPI.

12. A method for managing a plurality of critical functions in an aircraft, the method comprising:
obtaining a plurality of digital signals, wherein at least one digital signal of the plurality of digital signals is associated with a given critical function;
executing a plurality of critical applications managing the plurality of critical functions, each critical application with at least one digital signal of the plurality of digital signals, wherein the execution of the plurality of critical applications is managed by an operating system to accommodate fast loops and to ensure independence of the plurality of critical applications.

13. The method for managing a plurality of critical functions in an aircraft as claimed in claim 12, wherein the obtaining of a plurality of digital signals comprises receiving a plurality of analog signals and digitizing the plurality of digital signals to provide the plurality of digital signals.

14. The method for managing a plurality of critical functions in an aircraft as claimed in any one of claims 12 to 13, wherein more than one computing lane is provided, further wherein the executing of a plurality of critical applications managing the plurality of critical functions is performed using the more than one computing lane.

15. The method for managing a plurality of critical functions in an aircraft as claimed in claim 14, further comprising assigning a first portion of given critical application to a first given computing lane and a second portion of the given critical application to another computing lane.

16. The method for managing a plurality of critical functions in an aircraft as claimed in claim 15, wherein the assigning is amended.

17. A system for managing a plurality of critical functions in an aircraft, the system comprising:
at least one data providing unit for providing digital signals, wherein at least one digital signal is associated with a given critical function of the plurality of critical functions;
at least one transmission path coupled to the at least one data providing unit; and
at least one computing lane, the at least one computing lane for storing an operating system and a plurality of critical applications managing the plurality of functions and configured to receive the digital signals along the at least one transmission path, the processing unit for executing the operating system and the plurality of critical applications, wherein the execution of the plurality of critical applications is managed by the operating system to accommodate fast loops and to ensure independence of the plurality of critical applications.

18. The system for managing a plurality of critical functions in an aircraft as claimed in claim 17, wherein the system comprises a plurality of computing lanes, wherein at least one portion of a given application is executed by a given computing lane and at least one other portion of the given application is executed by another computing lane.

19. The system for managing a plurality of critical functions in an aircraft as claimed in claim 18, wherein the at least one portion of the given application is selected from a group consisting of a command (COM) portion and a monitoring (MON) portion.

20. The system for managing a plurality of critical functions in an aircraft as claimed in claim 18, wherein the at least one other portion of the given application is selected from a group consisting of a command (COM) portion and a monitoring (MON) portion.

21. The system for managing a plurality of critical functions in an aircraft as claimed in claim 18, wherein a processing using an outcome from the execution of the at least one portion of the given application and an outcome from the execution of the at least one other portion of the given application is further performed.

22. The system for managing a plurality of critical functions in an aircraft as claimed in claim 21, wherein the processing comprises one of performing a comparison, performing a vote and performing a selection.
